(19) United States
(12) Patent Application Publication
(10) Pub. No.: US 2011/0189400 A1
(43) Pub. Date: Aug. 4, 2011

(54) SUBSTRATE PROCESSING APPARATUS AND SUBSTRATE PROCESSING METHOD

(75) Inventor: Hiroshi Shinya, Koshi-Shi (JP)

(73) Assignee: Tokyo Electron Limited, Minato-Ku (JP)

(21) Appl. No.: 13/014,963

(22) Filed: Jan. 27, 2011

(30) Foreign Application Priority Data
Jan. 29, 2010 (JP) 2010-017715

(51) Int. Cl. B05D 3/04

(52) U.S. Cl. 427/299; 118/323

(57) ABSTRACT

Disclosed is a substrate processing apparatus for forming a coating film on a substrate, which includes; a nozzle having a slit-shaped ejection port for ejecting a coating solution onto the substrate, the ejection port being elongated in a width direction of the substrate; a relative movement mechanism configured to cause relative movement between the nozzle and the substrate to allow the substrate to be relatively scanned by the nozzle; and a first gas flow generating unit configured to generate a gas flow of an inert gas that flows, uniformly along a direction of the relative movement, at least within a zone on one side of the nozzle above an area of the substrate having been scanned by the nozzle.

### FIELD OF THE INVENTION

The present invention relates to a substrate processing apparatus and a substrate processing method that forms a coating film on a substrate by ejecting a coating solution from a nozzle onto the substrate, while relatively moving the substrate and the nozzle.

### BACKGROUND ART

In manufacturing of FPDs (Flat Panel Display), a circuit pattern is formed by a so-called photolithographic process. To be specific, the photolithographic process is performed in the following manner. At first, a predetermined film is formed on a substrate such as a glass substrate, and then a photoresist (hereinafter referred to as “resist”) as a coating solution is applied onto the substrate so that a resist film is formed on the substrate. Then, the resist film is exposed with an exposure pattern corresponding to a circuit pattern, and the exposed resist film is developed.

Recently, when a resist film is formed in the photolithographic process, there is generally employed a method that applies a resist solution onto a surface a substrate with the substrate being transported in horizontal posture, in order to improve throughput (see, JP2006-237482A, for example).

Specifically, a conventional resist coating apparatus 200 shown in FIG. 7 includes: a floating stage 201 for levitation transport of a glass substrate G (e.g., substrate for LCD) in an X-axis direction; a pair of guide rails 202 disposed on right and left sides of the floating stage 201 relative to the advancing direction of the glass substrate G; and four substrate carries 203 that slidably move on the guide rails 202, while holding four corner portions of the glass substrate G from below by suctioning.

A large number of gas jetting holes 201a for jetting a gas upward, and a large number of suction holes 201b are alternately formed in an upper surface of the floating stage 201 at predetermined intervals. By balancing an amount of the gas jetted from the gas jetting holes 201a and an amount of the gas suctioned by the suction holes 201b, the glass substrate G floats at a predetermined height from the surface of the floating stage 201. The resist coating apparatus 200 further includes a resist nozzle 205 that extends in the right and left direction (width direction) of the glass substrate G over the whole width of the glass substrate G to supply a resist solution onto the surface of the glass substrate G that is being subjected to the levitation transport above the floating stage 201.

In the resist coating apparatus 200 as structured above, the glass substrate G having been transferred from an apparatus for a precedent step is floated at a predetermined height by an airflow generated above the floating stage 201, while the four corners of the glass substrate G are held by the substrate carriers 203 by suctioning. When the glass substrate G is held by the substrate carriers 203, the substrate carriers 203 are moved along the rails 202 in the X direction, so that the substrate G is transported above the floating stage 201. When the substrate G passes below the resist nozzle 205, a resist solution is ejected from the tip of the resist nozzle 205, so that the resist solution is applied to the surface of the substrate G.

After the rest coating process has been performed in the resist coating apparatus 200, there is performed a vacuum drying process in which the substrate G is received into a chamber (not shown), and the interior the chamber is decompressed so as to dry the resist solution on the substrate G. Between the step in which the resist solution is applied to the substrate G and the step in which the substrate G is subjected to the vacuum drying process, the resist naturally dries. At this time, the resist might non-uniformly dry due to airflow and/or uneven temperature distribution in the atmosphere around the substrate, resulting in a non-uniform resist film.

In addition, as shown in FIG. 8, before and after the coating process and in the course of the coating process, the resist solution R is continuously exposed to the atmosphere at the tip of the nozzle 205. Thus, moisture (H₂O) or oxygen (O₂) contained in the atmosphere (air) may be introduced into the exposed resist solution R, which might cause gelation of the resist solution in the nozzle 205 (in the slit).

### SUMMARY OF THE INVENTION

The present invention provides a substrate processing apparatus and method for forming a coating film on a substrate by ejecting a coating solution from a nozzle onto the substrate while causing relate movement between the substrate and the nozzle, which are capable of performing a uniform coating process to the surface of the substrate.

According to a first aspect of the present invention, there is provided a substrate processing apparatus for forming a coating film on a substrate, including: a nozzle having a slit-shaped ejection port for ejecting a coating solution onto the substrate, the ejection port being elongated in a width direction of the substrate; a relative movement mechanism configured to cause relative movement between the nozzle and the substrate to allow the substrate to be relatively scanned by the nozzle; and a first gas flow generating unit configured to generate a gas flow of an inert gas that flows, uniformly along a direction of the relative movement, at least within a zone on one side of the nozzle above an area of the substrate having been scanned by the nozzle.

Preferably, the substrate processing apparatus further includes a second gas flow generating unit configured to generate a gas flow of an inert gas that flows, uniformly along a direction of the relative movement, at least within a zone on the other side of the nozzle above an area of the substrate not having been scanned by the nozzle.

According to a second aspect of the present invention, there is provided a substrate processing method that coats a coating solution onto a substrate so as to form a coating film thereon, said method including: ejecting a coating solution from an ejection port of a nozzle onto a surface, while causing relative movement between the substrate and the nozzle, the ejection port is slit-shaped and elongated in a width direction of the substrate; and generating a gas flow of an inert gas that flows, uniformly along a direction of the relative movement, at least within a zone on one side of the nozzle above an area of the substrate having been coated with the coating solution.

Preferably, the substrate processing method further includes generating a gas flow of an inert gas that flows, uniformly along a direction of the relative movement, at least within a zone on the other side of the nozzle above an area of the substrate not having been coated with the coating solution.

According to the present invention, the coating solution of the coating film which has been just coated onto the substrate is uniformly exposed to the gas flow of the inert gas. Thus, drying of the coating film formed on the substrate can be promoted, while coating unevenness, which might be caused by a turbulent flow, can be restrained.

### BRIEF DESCRIPTION OF THE DRAWINGS

FIG. 1 is a plan view showing an overall schematic structure of a substrate processing apparatus in one embodiment.

FIG. 2 is a side view showing the overall schematic structure of the substrate processing apparatus show in FIG. 1.

FIG. 3 is a front view of the substrate processing apparatus in FIG. 1 as viewed from the upstream side thereof.

FIG. 4 is a flowchart showing the process steps performed by the substrate processing apparatus.

FIGS. 5A and 5B are graphs for explaining control of gas flows formed on front and rear sides of a nozzle.

FIGS. 6A to 6C are sectional views for explaining the operations of the substrate processing apparatus.

FIG. 7 is a top view for explaining a schematic structure of a conventional coating unit.

FIG. 8 is a sectional view of a nozzle of the conventional coating unit.

FIG. 9 is a graph for explaining control of gas flows formed on front and rear, sides of the nozzle in another embodiment.

### EMBODIMENT FOR CARRYING OUT THE INVENTION

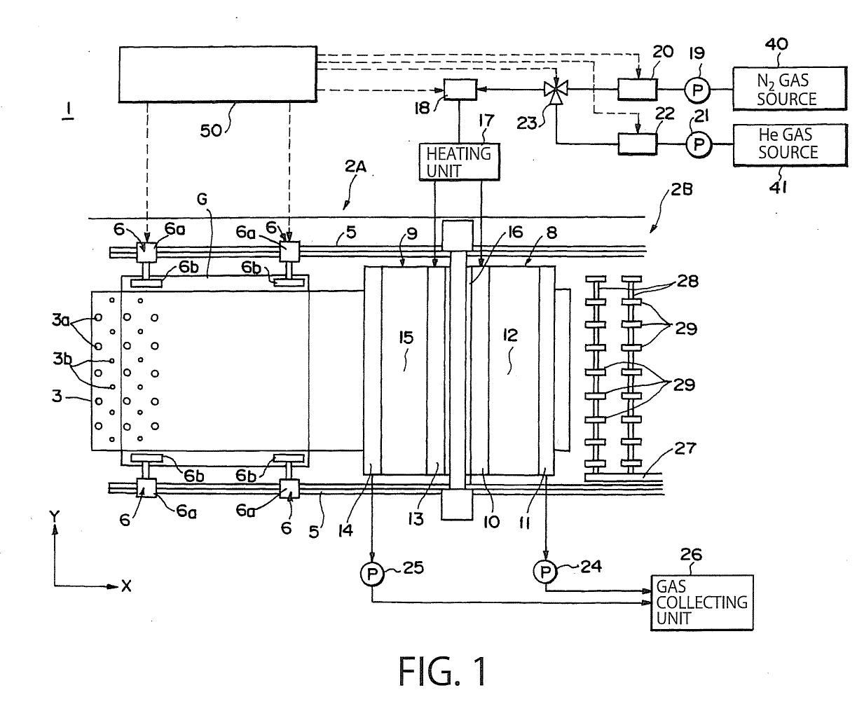

Herebelow, a substrate processing apparatus of the present invention in one embodiment will be described with reference to FIGS. 1 to 6. Given in this embodiment as an example to describe the present invention is a case where the substrate processing apparatus is a resist coating unit that coats a resist solution as a coating solution onto a glass substrate, which is a substrate to be processed, so as to form a coating film thereon, while the substrate is subjected to levitation transport.

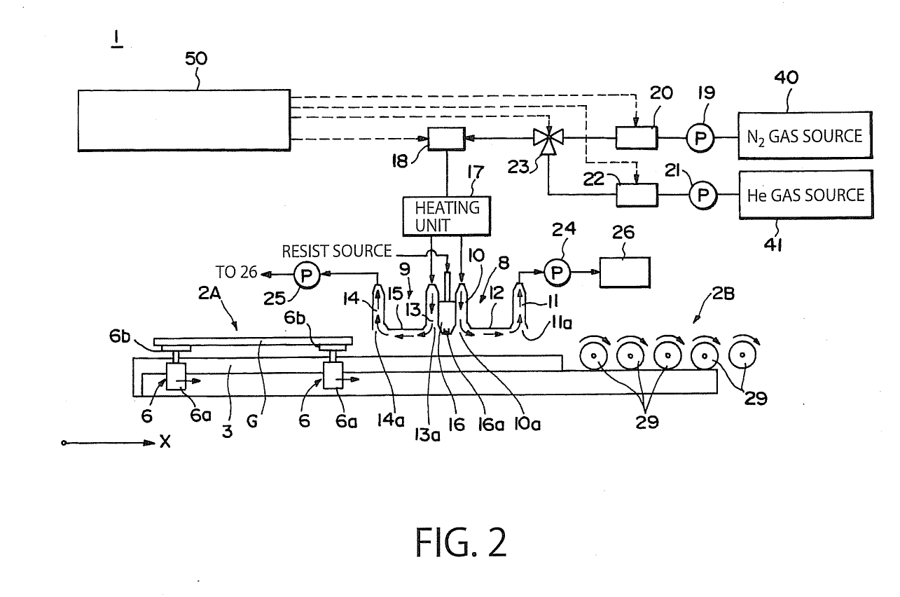

As shown in FIGS. 1 and 2, the substrate processing apparatus 1 includes: a levitation transport unit 2A that performs levitation transport of glass substrates G one by one; and a roller transport unit 2B that receives the substrates G from the levitation transport unit 2A and transports the substrate G using rollers. Inside the substrate processing apparatus 1, the substrate G is transported in a horizontal direction (one way), while the substrate G being maintained in horizontal posture. The levitation transport unit 2A is provided with a floating stage 3 extending in X direction that is the direction along which the substrates are transported (substrate transport direction). As illustrated, a large number of gas jetting holes 3a and a large number of gas suction holes 3b are alternately formed in the upper surface of the floating stage 3 at predetermined intervals in X direction and in Y direction. By balancing the amount of inert gas jetted from the gas jetting holes 3a and the amount of the gas sucked by the suction holes 3b, the glass substrate G can be floated up.

In this embodiment, the substrate G is floated by jetting of the gas and suction of the same. However, not limited thereto, the substrate may be floated up only by jetting a gas.

A pair of guide rails 5, extending in parallel with each other in X direction, are disposed on a right side and a left side of the floating stage 3 in a width direction (Y direction). Each of the guide rails 5 is equipped with two substrate carriers 6. Namely, four substrate carriers 6, which are provided to move along the guide rails 5 while holding four corner portions of the glass substrate G, are provided on the guide rails 5. The glass substrate G floating above the floating stage 3 is moved by these substrate carriers 6 along the transport direction (X direction). In order to smoothly transfer the substrate from the levitation transport unit 2A to the roller transport unit 2B, the guide rails are extended not only beside the right and left sides of the floating stage 3, but also to the right and left sides of the roller transport unit 2B.

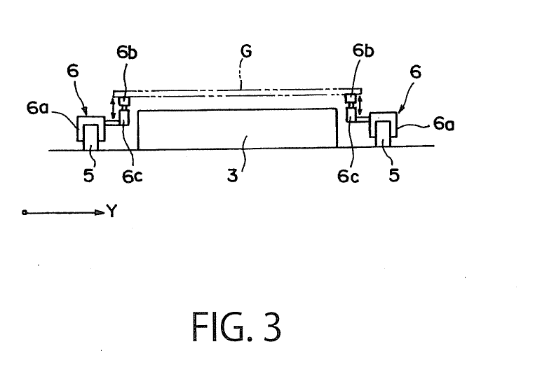

As shown in FIG. 3, each of the substrate carriers 6 is composed of: a slide member 6a capable of moving along the guide rail 5; a vacuum-chucking member 6b capable of releasably holding the lower surface of the substrate G by suctioning; and a cylinder driving unit 6c configured to vertically move (elevate and lower) the vacuum-chucking member 6b. A suction pump (not shown) is connected to the vacuum-chucking member 6a. The substrate G is held by the vacuum-chucking member 6b by suctioning, when the suction pump sucks air in the space between the vacuum-chucking member 6b and the substrate G to evacuate the same. Driving of the slide member 6a, the cylinder driving unit 6c and the suction pump is controlled by a control unit 50 (controller) comprising a computer.

As shown in FIGS. 1 and 2, a nozzle 16 is disposed above the floating stage 3 of the substrate processing apparatus 1 to eject a resist solution onto the glass substrate G. The nozzle 16 has a generally rectangular parallelepiped shape elongated in Y direction. The size of the nozzle 16 in Y direction is longer than the width of the glass substrate G in Y direction. As shown in FIG. 2, formed in the lower end (tip) of the nozzle 16 is a slit-shaped ejection port 16a that is elongated in the width direction of the floating stage 3. The nozzle 16 is supplied with a resist solution from a resist solution supply source (not shown).

In this embodiment, by moving the substrate G along the substrate transport direction (X direction) below the nozzle 16 that is immovable in the X direction, relative movement in X direction between the nozzle 16 and the substrate G is achieved. That is to say, a relative movement mechanism, which is configured to cause relative movement between the nozzle 16 and the substrate G to allow the substrate G to be relatively scanned by the nozzle 16, is constituted by the guide rails 5 and the substrate carriers 6.

In a zone on the front side of the ejection port 16a of the nozzle 16 with respect to the substrate transfer direction (X direction) (i.e., a zone above an area of the substrate G having been scanned by the nozzle 16 and coated with a coating solution) and a zone on the rear side of the ejection port (i.e., a zone above an area of the substrate G to be scanned by the nozzle 16 and not yet coated with the coating solution), gas flow generating units 8 and 9 are respectively arranged adjacent to the nozzle 16 to generate gas flows of an inert gas.

The gas flow generating unit 8 (first gas flow generating unit) adjacently located ahead of the nozzle 16 (downstream side of the nozzle 16 with respect to the advancing direction of the substrate G) includes: a gas supply unit 10 configured to supply an inert gas downward, namely, toward the floating stage 3, along one side surface of the nozzle 16; and a gas suction unit 11 located downstream (with respect to the advancing direction of the substrate G) of the gas supply unit 10 to suck upward the inert gas supplied from the gas supply unit 10.

The gas supply unit 10 and the gas suction unit 11 are respectively formed to have generally rectangular parallelepiped shapes elongated in Y direction, similarly to the nozzle 16. A gas supply port 10a and a gas suction port 11a are respectively formed in lower ends of the gas supply unit 10 and the gas suction unit 11. Similarly to the ejection port 16a of the nozzle 16, the gas supply port 10a and the gas suction port 11a are elongated along the width direction of the floating stage 3.

A rectifying plate 12 having a planar shape elongated in Y direction is disposed between the gas supply port 10a and the gas suction port 11a so as to face the floating stage 3 and thus a substrate G being processed. The rectifying plate 12 is located at a position higher than the tip of the nozzle 16 (the surface in which the ejection port 16a is formed) by a predetermined distance (e.g., a position higher than the distal end of the nozzle 16 by 2 to 5 mm).

As shown in FIG. 2, due to the structure of the gas flow generating unit 8, the inert gas blown downward from the gas supply unit 10 in the front-side area of the nozzle 16 flows uniformly downstream near the lower surface of the rectifying plate 12 in the substrate transport direction, and is sucked by the gas suction unit 11 to flow upward.

On the other hand, the gas flow generating unit 9 (second gas flow generating unit) adjacently located on the rear side of the nozzle 16 (upstream side of the nozzle 16 with respect to the substrate transport direction) includes: a gas supply nit 13 configured to supply an inert gas downward, namely, toward the floating stage 3, along the rear side surface of the nozzle 16; and a gas suction unit 14 located on the upstream (with respect to the substrate transport direction) of the gas supply unit 13 to suck upward the inert gas supplied from the gas supply unit 13.

The gas supply unit 13 and the gas suction unit 14 are respectively formed to have generally rectangular parallelepiped shapes elongated in Y direction, similarly to the nozzle 16. A gas supply port 13a and a gas suction port 14a are respectively formed in lower ends of the gas supply unit 13 and the gas suction unit 14. Similarly to the ejection port 16a of the nozzle 16, the gas supply port 13a and the gas suction port 14a are elongated along the width direction of the floating stage 3.

In addition, a rectifying plate 15 having a planar shape elongated in Y direction is disposed between the gas supply port 13a and the gas suction port 14a at a position higher than the tip of the nozzle 16 (the surface in which the ejection port 16a is formed) by a predetermined amount (e.g., a position higher than the distal end of the nozzle 16 by 2 to 5 mm).

As shown in FIG. 2, due to the structure of the gas flow generating unit 9, the inert gas blown downward from the gas supply unit 13 in the rear-side area of the nozzle 16 flows uniformly upstream near the lower surface of the rectifying plate 15, and is sucked by the gas suction unit 14 to flow upward.

Each of the gas supply units 10 and 13 is supplied with an inert gas which is heated and regulated to a predetermined temperature by a heating unit 17. The heating unit 17 is supplied with an inert gas whose flow rate is controlled by a flowrate controller 18.

In addition, in order to supply different inert gases to the substrate G in a resist ejection period and another period (ejection standby period), the inert gas supply system is configured to be switched to supply an optimum gas selected from a plurality of kinds of inert gases to the flowrate controller 18.

In this embodiment, for example, a gas, which is selected from two kinds of gases, i.e., nitrogen (N₂) gas that is dry and has a low dew point and helium (He) gas having a kinematic viscosity higher than that of air, is supplied.

That is to say, there are provided a pump configured to feed nitrogen gas from a nitrogen gas source 40, a flowrate controller 20 configured to control a flow rate of the nitrogen gas, a pump 21 configured to feed helium gas from a helium gas source 41, and a flowrate controller 22 configured to control a flow rate of the helium gas. By means of a switch valve 23, one of nitrogen gas and helium gas or mixture thereof can be supplied to the flowrate controller 18. Namely, the switch valve 23 also serves as a mixing valve.

Heating temperature of the heating unit 17 and operations of the flowrate controllers 18, 20 and 22, and the operation of the switch valve 23 are controlled by the controller 50. A gas supply unit is constituted by the nitrogen gas source 40, the helium gas source 41, the pumps 19 and 21, the flowrate controllers 18, 20 and 22, the switch valve 23, and the heating unit 17.

A suction pump 24 is connected to the gas suction unit 11, and a suction pump 25 is connected to the gas suction unit 14. Thus, the inert gases sucked by the respective pumps 24 and 25 are collected into a gas collecting unit 26. An arrangement may be provided to regenerate the inert gases collected in the gas collecting unit 26 and to return the regenerated gas to the gas supply sources 40 and 41 to recycle the same.

As described above, the roller transport unit 2B is disposed subsequently to the levitation transport unit 2A. In the roller transport unit 2B following the stage 3, a plurality of roller shafts 28, which are driven for rotation by a roller driving unit 27, are arranged in parallel with each other. Each of the roller shafts 28 has transport rollers 29. The substrate G is transported by rotating the transfer rollers 29.

Next, process steps of a resist coating process to the substrate G performed in the substrate processing apparatus 1 as structured above will be described.

In a substrate processing apparatus 1, when a new glass substrate G is loaded onto the floating stage 3, the substrate G is supported from below by the airflow of an inert gas generated above the floating stage 3, and is held by the substrate carriers 6.

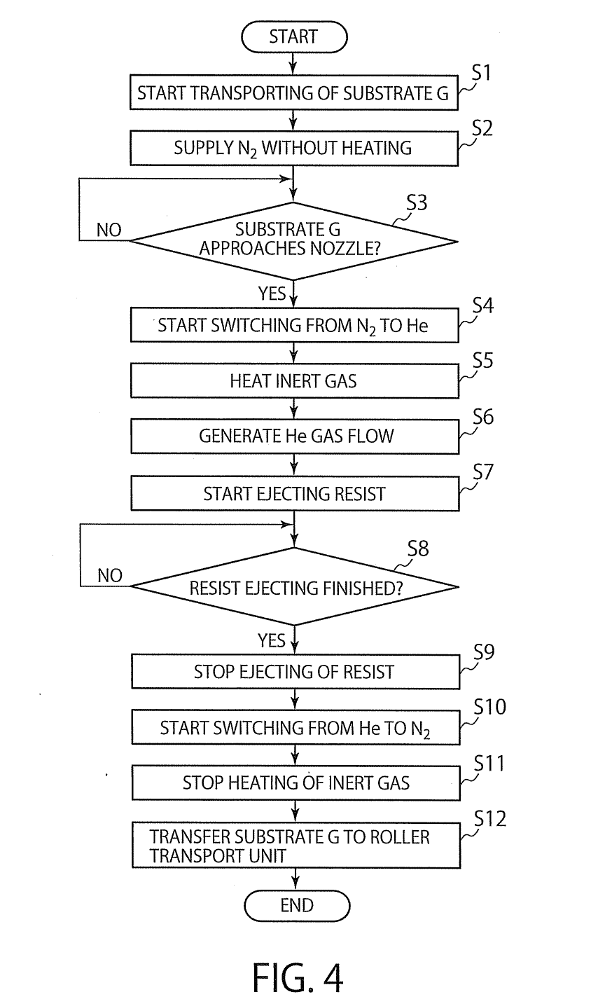

Then, the substrate carriers 6 are driven under the control of the controller 50, so that transporting of the substrate G in the substrate transport direction starts (step S1 in FIG. 4).

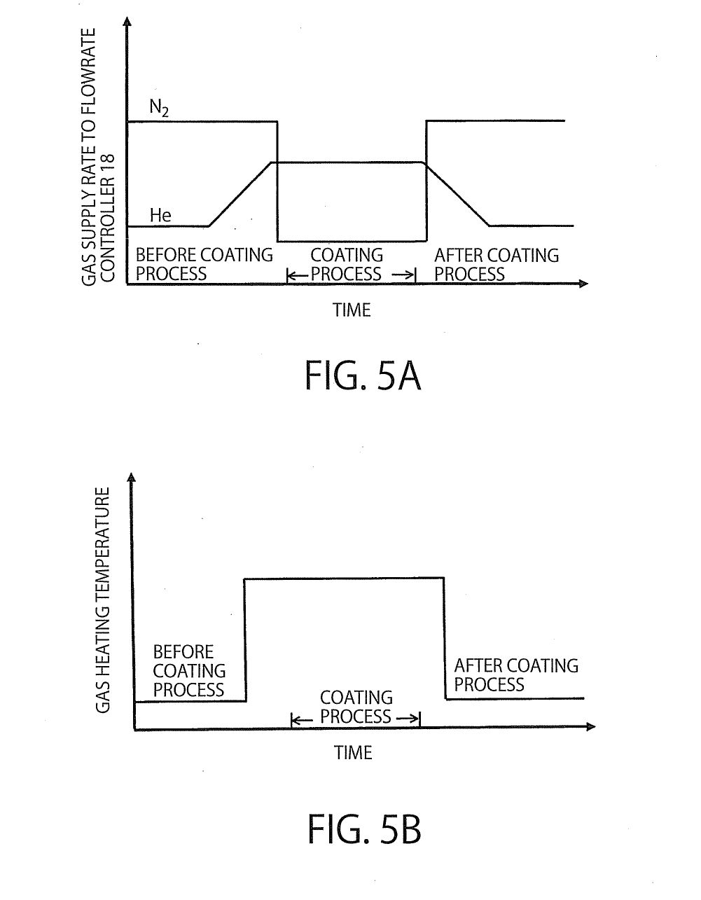

When the transport of the substrate G is started, as shown in the period of “Before Coating Process” in FIG. 5A, nitrogen gas is supplied to the flowrate controller 18 via the switch valve 23. In addition, as shown in the period of “After Coating Process” in FIG. 5B, the nitrogen gas without being heated by the heating unit 17 is fed to the gas supply units 10 and 13 of the gas flow generating units 8 and 9.

The nitrogen gas is blown out from the gas supply ports 10a and 13a of the gas supply units 10 and 13. The nitrogen gas flows near the bottom surfaces of the rectifying plates 12 and 15, and is sucked up by the gas suction units 11 and 14 to flow upward (step S2 in FIG. 4).

Thus, at the tip portion of the nozzle 16 which is being standing-by (i.e., not ejecting the resist solution), contact between the resist solution R exposed from the ejection port 16a and the atmospheric air can be prevented, by means of the uniform gas flows of nitrogen gas, which are respectively generated toward the upstream direction and the downstream direction of the ejection port 16a.

Namely, owing to the flows of the dry nitrogen gas having a low dew point, humidity and oxygen (O₂) concentration of the atmosphere around the tip of the nozzle 16 are decreased, whereby incorporation of moisture and oxygen into the resist solution R (and thus the gelation of the resist solution in the nozzle 16) is suppressed.

When the front end of the substrate G being transported above the floating stage 3 is detected by, for example, a sensor (not shown), and the substrate G approaches the nozzle 16 (step S3 in FIG. 4), the control unit 50 gradually changes the status of the switch valve 23. Thus, as shown in the period of “Before Coating Process” in FIG. 5A, the flowrate of helium gas to be supplied to the flowrate controller 18 is gradually increased (step S4 in FIG. 4). With the introduction of helium gas to the flowrate controller 18, as shown in FIG. 5B, the heating unit 17 starts to heat and control the gas to a predetermined temperature (e.g., 30° C. to 40° C.) (step S5 in FIG. 4).

The concentration of helium gas in the inert gas supplied to the gas supply units 10 and 13 of the gas flow generating units 8 and 9 is gradually increased. Then, as shown in FIG. 5A, immediately before the starting of the coating process, the supply of nitrogen gas to the flowrate controller 18 is completely stopped by the switch valve 23, and only helium gas is supplied to the flowrate controller 18. Thus, immediately before the starting of the coating process, only helium gas that has been heated at a predetermined temperature is fed to the gas supply ports 10a and 13a of the gas supply units 10 and 13.

Thus, there are generated flows of warm helium gas, which is blown downward from the gas supply ports 10a and 13a, flows near the bottom surfaces of the rectifying plates 12 and 15, and then is sucked upward by the gas suction units 11 and 14 (step S6 in FIG. 4).

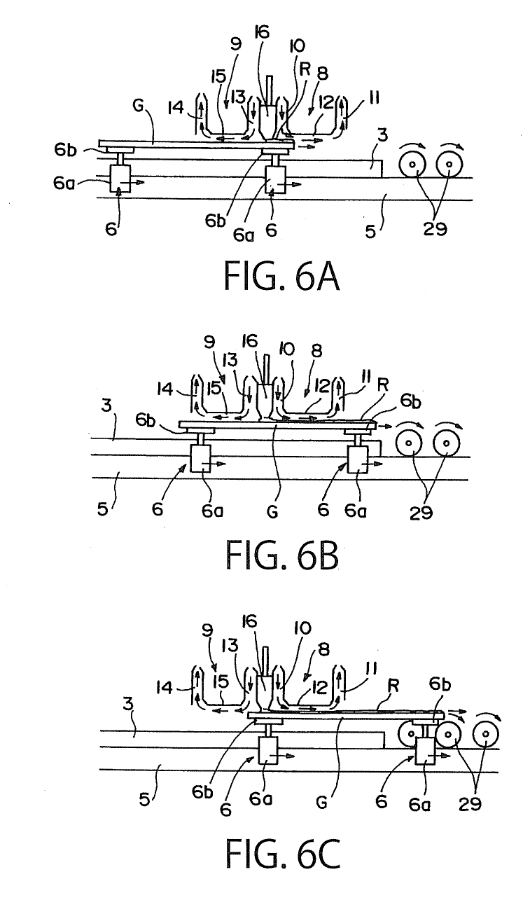

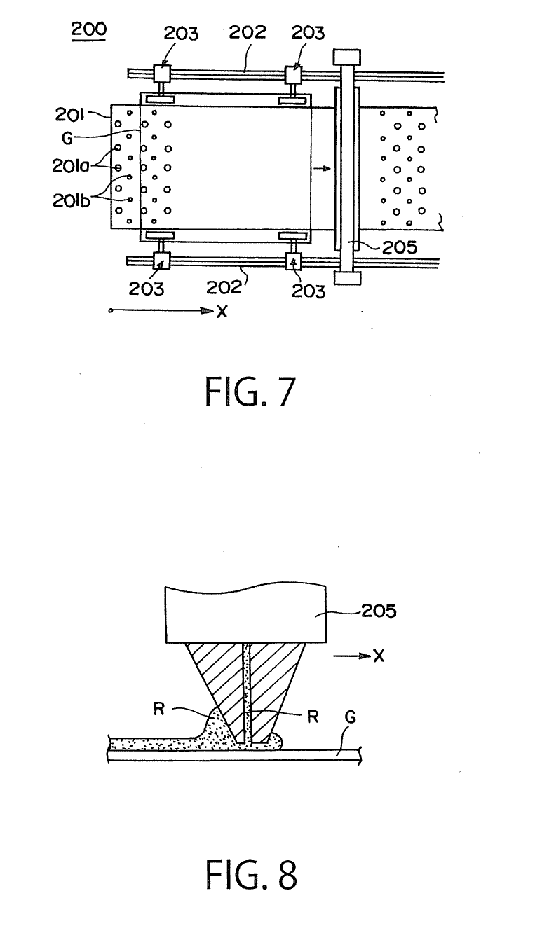

FIG. 6A is a side view showing the state immediately after the start of the coating process to the substrate G. FIG. 6B is a side view showing the state in the course of the coating process to the substrate G. FIG. 6C is a side view showing the state immediately before the completion of the coating process to the substrate G. After the gas flows of helium gas have been generated by the gas flow generating units 8 and 9 in the front-side area and the rear-side area of the nozzle ejection port 16a, the resist solution R is ejected from the resist nozzle 16, whereby the application of the resist solution R onto the substrate G is started is firstly to the front end of the substrate G as shown in FIG. 6A (step S7 in FIG. 4), and then the resist solution R is applied to the center part of the substrate G as shown in FIG. 6B, and then to the rear end of the substrate G as shown in FIG. 6C.

As shown in FIGS. 6A to 6C, during the resist coating period, a film-like resist solution R that has been just applied onto the substrate G is uniformly exposed to the warm gas flow of helium gas generated below the rectifying plate 12 of the gas flow generating unit 8. Thus, drying of the film-like resist solution R on the substrate G is promoted, while coating unevenness, which might be caused by a turbulent flow, is restrained. Further, since helium gas has a lower density and a higher kinetic viscosity than those of air, the helium gas forming the gas flow above the substrate G can decrease the Raynolds number (increase the viscosity) of the atmosphere above the resist film. Thus, the uniformity of the coating film is improved.

As shown in FIGS. 6(a) to 6(c), during the resist coating period, not only in the zone on the downstream side of the nozzle 16 (downstream side of the substrate G in the transport direction, i.e., above the area of the substrate G immediately after being coated) but also in the zone on the upstream side of the nozzle 16 (i.e., above the area of the substrate G immediately before being coated), the gas flow of helium gas is generated by the gas flow generating unit 9. Thus, since contact between the resist solution R exposed from the ejection port 16a of the nozzle 16 and the atmospheric air can be prevented, and gelation of the resist solution R in the nozzle 16 can be restrained.

After the application of the resist solution R onto the substrate G has been completed (step S8 in FIG. 4), the ejection of the resist solution R from the nozzle 16 is stopped (step S9 in FIG. 4). As shown in the period of “After Coating Process” in FIG. 5A, the status of the switch valve 23 is changed such that the supply of nitrogen gas to the flowrate controller 18 is started again, and the supply rate of the helium gas is gradually decreased (step S10 in FIG. 4). In addition, as shown in the period of “After Coating Process” in FIG. 5B, the heating of the inert gas by the heating unit 17 is stopped (step S11 of FIG. 4). Thus, similarly to the state before the resist is ejected, dry nitrogen gas having a low dew point is blown out from the gas supply ports 10a and 13a of the gas supply units 10 and 13, whereby gelation of the resist R in the nozzle 16 can be restrained.

The substrate G, which has been completely coated with the resist solution R above the floating stage 3, is transferred from the levitation transport unit 2A to the roller transport unit 2B. Then, the substrate G is transported by rolling transporting to a succeeding processing unit (step S12 in FIG. 4).

As described above, according to the above embodiment, during the period in which the resist solution R is ejected from the nozzle 16 (resist solution ejection period), the film of the resist solution R which has been just applied onto the substrate G is uniformly exposed to the warm gas flow of helium gas having a high kinetic viscosity. Thus, drying of the film of the resist solution R on the substrate G can be promoted, while the coating unevenness, which might be caused by a turbulent flow, can be restrained. Further, since helium gas has a lower density and a higher kinetic viscosity than those of air, the helium gas forming the gas flow above the substrate G can decrease the Raynolds number (increase the viscosity) of the atmosphere above the resist film. Thus, the uniformity of the coating film is improved.

In addition, in the standby (non-ejecting) period of the nozzle 16, owing to the uniform gas flows of nitrogen gas formed in the front and rear areas of the ejection port 16a, contact between the resist solution R exposed from the ejection port 16a and the atmospheric air can be restrained. Thus, humidity and oxygen (O₂) concentration in the atmospheric air around the tip of the nozzle 16 are reduced, whereby incorporation of moisture and oxygen into the resist solution R (and thus the gelation of the resist solution in the nozzle 16) is suppressed.

In the foregoing embodiment, during the period in which the resist solution R is ejected from the nozzle 16, gas flows of warm helium gas having a kinetic viscosity higher than that of air are formed; while during the ejection standby period of the nozzle 16, gas flows of dry nitrogen gas having a low dew point are generated. However, the gases to be used are not limited thereto, and another inert gas may be used in place of helium gas and nitrogen gas.

In the above embodiment, a coating film is formed on the substrate G in the horizontal posture which is transported above the floating stage 3 in the horizontal single direction. However, the manner of substrate transport is not limited thereto, as long as the nozzle for ejecting a coating solution and the substrate are relatively moved. For example, the substrate G may be fixedly placed (absorbed) on a stage, while the stage may be moved below a stationary nozzle. Alternatively, the substrate G may be fixedly placed (absorbed) on a stationary stage, and a nozzle may be moved above this state, so that the relative movement of the nozzle and the substrate is achieved whereby the substrate is relatively scanned by the nozzle. In this case, “the relative movement mechanism configured to cause relative movement between the nozzle and the substrate to allow the substrate to be relatively scanned by the nozzle” is constituted by the nozzle moving mechanism (not shown). Also in this case, the gas flow generating unit 8 and 9 are provided to move together with the nozzle.

In the above embodiment, although the substrate processing apparatus is embodied as the resist coating unit, the present invention is not limited thereto, and the substrate processing apparatus may be one that performs formation of another coating film.

Next, there is described examination on kinds of inert gases used for generating gas flows ahead of and behind a nozzle in the resist coating process.

An inert gas used in the embodiment preferably decreases the Raynolds number (increase the viscosity) of an atmosphere above a resist film, thereby to restrain occurrence of defects such as coating unevenness, which might be caused by a turbulent flow that is generated immediately after the resist-solution coating process.

Thus, the kinetic viscosities of inert gases were examined in order to reduce the Raynolds number Re that is calculated from the following expression (1). In Expression (1), “U” represents the characteristic velocity (m/s), “L” represents the characteristic length (m), and “ν” represents the kinetic viscosity (m²/s).

Re=UL/ν Expression 1

Since the kinetic viscosity “ν” is calculated from the following Expression (2), the viscosity coefficients “μ” and the densities “ρ” of plural kinds of gases were examined.

ν=μ/ρ Expression 2

Table 1 shows the densities “ρ” (g/cm³) of plural kinds of gases.

TABLE 1

| Gas | Molecular Weight | Density (g/cm³) |
|---|---|---|
| H₂ | 2.0160 | 0.00008 |
| He | 4.0030 | 0.00016 |
| NH₃ | 17.030 | 0.00070 |
| Ne | 20.179 | 0.00083 |
| N₂ | 28.010 | 0.00115 |
| air | 28.966 | 0.00119 |
| O₂ | 32.000 | 0.00132 |
| Ar | 39.950 | 0.00165 |
| CO₂ | 44.010 | 0.00181 |
| Kr | 83.800 | 0.00345 |
| Xe | 131.30 | 0.00541 |

As shown in Table 1, among the inert gases, the density of helium (He) gas is the smallest. Table 2 shows viscosity coefficients “μ” of the plural kinds of gases including helium gas.

TABLE 2

| | Molecular | Viscosity Coefficient μ (P) | | |
|---|---|---|---|---|
| Gas | Weight | 20° C. | 50° C. | 100° C. |
| He | 4.000 | 196 | 208 | 229 |
| N₂ | 28.01 | 174 | 187 | 209 |
| air | 28.97 | 181 | 195 | 218 |
| O₂ | 32.00 | 203 | 218 | 244 |

By using the viscosity coefficient at a gas temperature of 20° C. from Table 2, the kinetic viscosity of helium gas was calculated as follows: ν (helium gas)=1.23×10⁻⁴ (m²/s). On the other hand, by using the viscosity coefficient at a gas temperature of 20° C., the kinetic viscosity of air was calculated as follows: ν (air)=1.52×10⁻⁵ (m²/s). Namely, it could be understood that, since the kinetic viscosity of helium gas is higher than the kinetic viscosity of air at a gas temperature of 20° C., the use of helium gas can decrease the Raynolds number Re of the atmosphere around the substrate as compared with air. Thus, immediately after the resist-solution coating process, by exposing the resist film to a gas flow of helium gas, the Raynolds number of the atmosphere above the resist film can be decreased (the viscosity can be increased), whereby occurrence of defects such as coating unevenness, which might be caused by a turbulent flow, can be restrained.

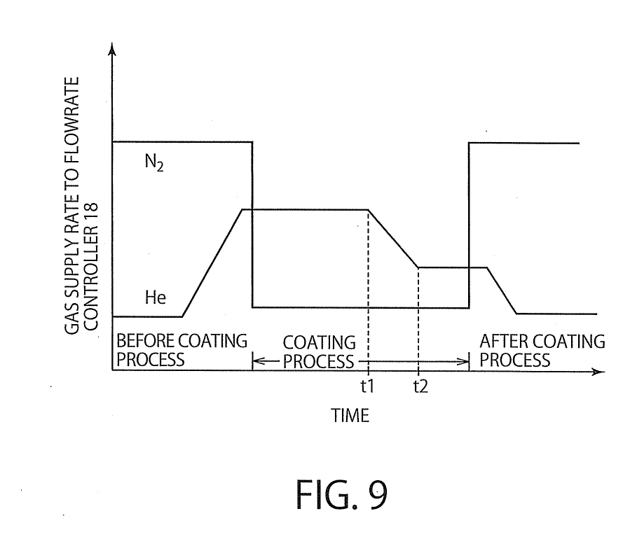

Although the flow rates of the gases to be supplied are controlled as shown in FIG. 5A in the foregoing embodiment, the gas supply flow rates may be controlled as shown in FIG. 9. The change of the nitrogen gas supply rate with time shown in FIG. 9 is the same as that shown in FIG. 5A. The helium gas supply rate shown in FIG. 9 is the same as that shown in FIG. 5A in “Before Coating Process” and from the starting of “Coating Process” to the midway of the “Coating Process”. The helium gas supply rate is started to be decreased at a time point t1 in the course of the coating process, and the helium gas supply rate is gradually decreased up to a time point t2 in the course of the coating process. From the time point t2, helium gas is supplied at a predetermined constant flow rate. After “Coating Process”, the helium gas supply rate is decreased to a supply rate that is the same as that shown in FIG. 5A. By controlling the helium gas supply rate in this manner, the helium gas consumption can be reduced as compared with the case shown in FIG. 5A, while the helium atmosphere required for the coating process can be established.

Although helium gas is used in the forgoing embodiment, neon gas (Ne) or xenon gas (Xe) may be used instead of helium gas.

1. A substrate processing apparatus for forming a coating film on a substrate, comprising:
a nozzle having a slit-shaped ejection port for ejecting a coating solution onto the substrate, the ejection port being elongated in a width direction of the substrate;
a relative movement mechanism configured to cause relative movement between the nozzle and the substrate to allow the substrate to be relatively scanned by the nozzle; and
a first gas flow generating unit configured to generate a gas flow of an inert gas that flows, uniformly along a direction of the relative movement, at least within a zone on one side of the nozzle above an area of the substrate having been scanned by the nozzle.

2. The substrate processing apparatus according to claim 1, further comprising a second gas flow generating unit configured to generate a gas flow of an inert gas that flows, uniformly along a direction of the relative movement, at least within a zone on the other side of the nozzle above an area of the substrate not having been scanned by the nozzle.

3. The substrate processing apparatus according to claim 2, wherein the first gas flow generating unit includes:
a gas supply port disposed parallel and adjacent to the ejection port to jet an inert gas toward the substrate;
a gas suction port disposed parallel to the ejection port and located farther from the ejection port than the gas supply port; and
a rectifying plate disposed between the gas supply port and the gas suction port to face the substrate.

4. The substrate processing apparatus according to claim 1, further comprising:
a gas supply unit including a switch valve and configured to be capable of supplying different inert gases to the first gas flow generating unit upon switching of the switch valve; and
a controller configured to perform control of the switch valve and control of supply of the coating solution from the nozzle,
wherein the controller is configured to control the switch valve such that an inert gas supplied to the first gas flow generating unit in an ejection standby period is different from an inert gas supplied to the first gas flow generating unit in an ejection period.

5. The substrate processing apparatus according to claim 4, wherein:
the inert gas supplied to the first gas flow generating unit in a coating solution ejection period comprises Helium (He) gas; and
the inert gas supplied to the first gas flow generating unit in an ejection standby period comprises nitrogen (N₂) gas.

6. The substrate processing apparatus according to claim 5, further comprising:
a heating unit configured to heat the inert gas supplied to the first gas flow generating unit,
wherein the controller is configured to control the heating unit such that temperature of the inert gas supplied to the first gas flow generating unit in the coating solution ejection period is higher than temperature of the inert gas supplied to the first gas flow generating unit in the ejection standby period.

7. The substrate processing apparatus according to claim 1, wherein the first gas flow generating unit includes:
a gas supply port disposed parallel and adjacent to the ejection port to jet an inert gas toward the substrate;
a gas suction port disposed parallel to the ejection port and located farther from the ejection port than the gas supply port; and
a rectifying plate disposed between the gas supply port and the gas suction port to face the substrate.

8. The substrate processing apparatus according to claim 4, further comprising:
a heating unit configured to heat the inert gas supplied to the first gas flow generating unit,
wherein the controller is configured to control the heating unit such that temperature of the inert gas supplied to the first gas flow generating unit in a coating solution ejection period is higher than temperature of the inert gas supplied to the first gas flow generating unit in an ejection standby period.

9. A substrate processing method that coats a coating solution onto a substrate so as to form a coating film thereon, said method comprising:
ejecting a coating solution from an ejection port of a nozzle onto a surface, while causing relative movement between the substrate and the nozzle, the ejection port is slit-shaped and elongated in a width direction of the substrate; and
generating a gas flow of an inert gas that flows, uniformly along a direction of the relative movement, at least within a zone on one side of the nozzle above an area of the substrate having been coated with the coating solution.

10. The substrate processing method according to claim 9, further comprising generating a gas flow of an inert gas that flows, uniformly along a direction of the relative movement, at least within a zone on the other side of the nozzle above an area of the substrate not having been coated with the coating solution.

11. The substrate processing method according to claim 10, wherein different inert gases are used for generating the gas flow in a coating gas ejection period and an ejection standby period.

12. The substrate processing method according to claim 10, wherein:
the inert gas generating the gas flow in a coating solution ejection period is Helium (He) gas; and
the inert gas generating the gas flow in an ejection standby period is nitrogen (N₂) gas.

13. The substrate processing method according to claim 10, wherein temperature of the inert gas supplied in a coating solution ejection period is higher than temperature of the inert gas supplied in an ejection standby period.

14. The substrate processing method according to claim 9, wherein different inert gases are used for generating the gas flow in a coating gas ejection period and an ejection standby period.

15. The substrate processing method according to claim 9, wherein:
the inert gas generating the gas flow in a coating solution ejection period is Helium (He) gas; and
the inert gas generating the gas flow in an ejection standby period is nitrogen (N₂) gas.

16. The substrate processing method according to claim 10, wherein temperature of the inert gas supplied in a coating solution ejection period is higher than temperature of the inert gas supplied in an ejection standby period.
